(19) United States
(12) Patent Application Publication
(10) Pub. No.: US 2021/0102635 A1
(43) Pub. Date: Apr. 8, 2021

(54) VALVE DEVICE

(71) Applicant: DENSO CORPORATION, Kariya-city (JP)

(72) Inventors: Shinji KAWADA, Kariya-city (JP); Seiji TATEISHI, Kariya-city (JP); Hikaru OTSUKA, Kariya-city (JP); Hiroto INOUE, Kariya-city (JP); Shin KUWATA, Kariya-city (JP); Tetsuya ITO, Kariya-city (JP); Shinji HASHIMOTO, Kariya-city (JP)

(21) Appl. No.: 17/110,119

(22) Filed: Dec. 2, 2020

Related U.S. Application Data
(63) Continuation of application No. PCT/JP2019/022264, filed on Jun. 5, 2019.

(30) Foreign Application Priority Data
Jun. 7, 2018 (JP) 2018-109448

(51) Int. Cl. F16K 31/04; B60H 1/32; F16K 31/08; F16K 31/53; F16H 25/20

(52) U.S. Cl. CPC F16K 31/04; B60H 1/32; F16H 25/20; F16K 31/53; F16K 31/08

(57) ABSTRACT

A valve device includes a valve, a drive device, a magnet coupling, and a screw mechanism. The valve includes a valve body and changes a flow mode of refrigerant flowing in a circulation path of a refrigeration cycle device. The drive device includes an electric drive unit as a drive source. The magnet coupling includes a driving-side rotary body and a driven-side rotary body that are magnetically connected to each other in a non-contact manner and transmits a rotary motion of the electric drive unit from the driving-side rotary body to the driven-side rotary body. The screw mechanism converts the rotary motion of the driven-side rotary body into an axial linear motion of the valve body. The valve device is configured to change the flow mode of refrigerant by using the linear motion of the valve body caused via the magnet coupling and the screw mechanism in response to the drive of the electric drive unit.

### CROSS REFERENCE TO RELATED APPLICATION

The present application is a continuation application of International Patent Application No. PCT/JP2019/022264 filed on Jun. 5, 2019, which designated the U.S. and claims the benefit of priority from Japanese Patent Application No. 2018-109448 filed on Jun. 7, 2018. The entire disclosures of all of the above applications are incorporated herein by reference.

### TECHNICAL FIELD

The present disclosure relates to an electric valve device.

### BACKGROUND

A valve device such as a flow control valve device has been used in a refrigeration cycle device. The valve device may include an electric drive unit such as an electric motor.

### SUMMARY

According to an aspect of the present disclosure, a valve device incudes a valve, a drive device that drives the valve, a magnet coupling, and a screw mechanism. The valve includes a valve body and changes a flow mode of refrigerant flowing in a circulation path of a refrigeration cycle device.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing a refrigeration cycle device including a valve device according to an embodiment;

FIG. 2 is a schematic diagram showing an expansion valve device;

FIG. 3 is a perspective view showing a configuration of a closing plate;

FIG. 4 is a perspective view showing a configuration of a closing plate according to another example;

FIG. 5 is a cross-sectional view showing a configuration around a valve according to another example; and

FIG. 6 is a cross-sectional view showing a configuration of a magnet coupling according to another example.

### DETAILED DESCRIPTION

As follows, examples of the present disclosure will be described.

According to an example of the present disclosure, a valve device such as a flow control valve used in a refrigeration cycle device includes a motor as an electric drive unit and a screw mechanism that converts a rotary motion of a rotor of the motor into a linear motion. The valve device converts the linear motion into a forward and backward motion of a valve body.

According to an example of the present disclosure, a configuration is conceived to use the screw mechanism. The screw mechanism may cause rattling in a meshing part between a male screw part and a female screw part. This rattling may cause rattling of the valve body and may exert an effect on the performance of the valve device. Therefore, an urging member may be employed to cause the urging member to apply an urging force to a movable portion on a drive transmission path from the rotor of the motor to the valve body to suppress the rattling.

The present inventor is investigating to omit the urging member, which is for the purpose of suppressing the rattling of the valve body, and to simplify the valve device as much as possible.

According to an example of the present discourse, a valve device incudes a valve, a drive device that drives the valve, a magnet coupling, and a screw mechanism. The valve includes a valve body and changes a flow mode of refrigerant flowing in a circulation path of a refrigeration cycle device. The drive device includes an electric drive unit as a drive source. The magnet coupling includes a driving-side rotary body and a driven-side rotary body that are magnetically coupled to each other in a non-contact manner. The magnet coupling is configured to transmit a rotary motion of the electric drive unit from the driving-side rotary body to the driven-side rotary body. The screw mechanism is configured to convert the rotary motion of the driven-side rotary body into a linear motion of the valve body in an axial direction. The valve device is configured to change the flow mode of refrigerant by using the linear motion of the valve body caused via the magnet coupling and the screw mechanism in response to driving of the electric drive unit.

According to this example, the valve device is configured to convert the rotary drive motion of the electric drive unit into the linear motion of the valve body via the magnet coupling and the screw mechanism. This configuration enables to cause an attractive force generated in the magnet coupling (that is, an attractive force between the driving-side rotary body and the driven-side rotary body) to act on the screw mechanism that has the structure to cause rattling. Therefore, the configuration may enable to suppress rattling of the screw mechanism and the rattling of the valve body.

Hereinafter, an embodiment of a valve device will be described with reference to the drawings. In the drawings, a part of the configuration may be exaggerated or simplified for convenience of description. In addition, a dimensional ratio of each component may be different from the actual dimensional ratio.

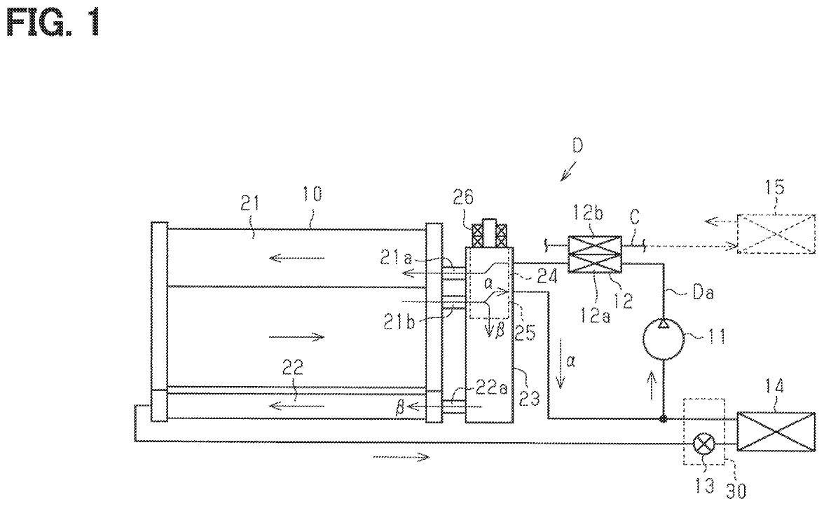

As shown in FIG. 1, a heat exchanger 10 of the present embodiment is used for a refrigeration cycle device D (heat pump cycle device) for air conditioning of an electric vehicle (hybrid vehicle, EV vehicle, and the like). The vehicle air conditioning device 1 includes a refrigeration cycle 3 and is configured to switch between a cooling mode that blows air cooled by using an evaporator 14 into a passenger compartment and a heating mode that blows air warmed by using a heater core 15 into the passenger compartment. Further, a refrigerant circulation circuit Da of the refrigeration cycle device D is configured to switch between a circulation circuit corresponding to the cooling mode (cooling circulation path α) and a circulation circuit corresponding to the heating mode (heating circulation path β) . . . . Herein, HFC refrigerant or HFO refrigerant, for example, may be used as the refrigerant circulating in the refrigerant circulation circuit Da of the refrigeration cycle device D. Oil for lubricating a compressor 11 is desirably mixed in the refrigerant.

The refrigeration cycle device D includes the compressor 11, a water cooling condenser 12, the heat exchanger 10, an expansion valve 13 as a valve (expansion valve device 30 as a valve device), and the evaporator 14 in the refrigerant circulation circuit Da.

The compressor 11 is an electric compressor arranged in an engine room outside the vehicle interior. The compressor 11 draws and compresses gas phase refrigerant and discharges vapor-phase refrigerant in a superheat state (high temperature and high pressure) to the water cooling condenser 12. The high temperature and high pressure refrigerant discharged from the compressor 11 flows into the water cooling condenser 12. As a compression mechanism of the compressor 11, various compression mechanisms such as a scroll compression mechanism and a vane compression mechanism may be employed. Further, the compressor 11 is configured to control a refrigerant discharge capacity.

The water cooling condenser 12 is a known heat exchanger. The water cooling condenser 12 includes a first heat exchange portion 12a provided on the refrigerant circulation circuit Da and a second heat exchange portion provided on a cooling water circulation circuit C in the cooling water circulation device. The heater core 15 is provided to the circulation circuit C. The water cooling condenser 12 causes heat exchange between the vapor-phase refrigerant flowing in the first heat exchange portion 12a and the cooling water flowing in a second heat exchange portion 12b. That is, in the water cooling condenser 12, cooling water in the second heat exchange portion 12b is heated by heat of the vapor-phase refrigerant in the first heat exchange portion 12a, while the vapor-phase refrigerant in the first heat exchange portion 12a is cooled. Therefore, the water cooling condenser 12 functions as a radiator that dissipates the heat of the refrigerant discharged from the compressor 11 and flowing into the first heat exchange portion 12a to blown air of the vehicle air conditioner via the cooling water and the heater core 15.

The vapor-phase refrigerant that has passed through the first heat exchange portion 12a of the water cooling condenser 12 flows into the heat exchanger 10 through an integrated valve device 24 that will be described later. The heat exchanger 10 is an external heat exchanger arranged on the front side of the vehicle in the engine room outside the vehicle interior. The heat exchanger 10 exchanges heat between the refrigerant flowing inside the heat exchanger 10 and the external air (outside air) blown by a blower fan (not shown).

Specifically, the heat exchanger 10 includes a first heat exchange portion 21 and a second heat exchange portion 22 that functions as a sub-cooler. Further, the heat exchanger 10 is integrally constructed with a liquid reservoir 23, which is connected to the first and second heat exchange portions 21 and 22, and an integrated valve device 24 provided to the liquid reservoir 23. An inflow path 21a and an outflow path 21b of the first heat exchange portion 21 are in communication with the integrated valve device 24. Further, an inflow path 22a of the second heat exchange portion 22 is in communication with the liquid reservoir 23 and the integrated valve device 24.

The first heat exchange portion 21 functions as a condenser or an evaporator according to the temperature of the refrigerant which circulates therein. The liquid reservoir 23 is configured to separate vapor-phase refrigerant and liquid-phase refrigerant, and the separated liquid-phase refrigerant is stored in the liquid reservoir 23. The second heat exchange portion 22 exchanges heat between the liquid phase refrigerant flowing from the liquid reservoir 23 and the external air, thereby to further cool the liquid phase refrigerant to increase a degree of super-cooling of the refrigerant. The second heat exchange portion 22 causes the refrigerant after performing the heat exchange to flow to the expansion valve 13. The first heat exchange portion 21, the second heat exchange portion 22, and the liquid reservoir 23 are connected to each other with, for example, bolt fastening and are integrated together.

The integrated valve device 24 includes a valve main body 25 arranged in the liquid reservoir 23 and an electric drive unit 26 for driving the valve main body 25. The integrated valve device 24 is an electric valve device that uses a motor (for example, a stepping motor) for the electric drive unit 26. The integrated valve device 24 forms a heating circulation path α in the heating mode in which the first heat exchange portion 12a of the water cooling condenser 12 and the inflow path 21a of the first heat exchange portion 21 communicate with each other, and at the same time, the outflow path 21b of the first heat exchange portion 21 directly communicates with the compressor 11. Further, the integrated valve device 24 forms a cooling circulation pathway 13 in the cooling mode in which the first heat exchange portion 12a of the water cooling condenser 12 and the inflow path 21a of the first heat exchange portion 21 communicate with each other, and at the same time, the outflow path 21b of the first heat exchange portion 21 communicate with the compressor 11 through the second heat exchange portion 22, the expansion valve 13, and the evaporator 14. When stopped, the integrated valve device 24 closes all the flow passages. In other words, the integrated valve device 24 operates the valve main body 25 by driving the electric drive unit 26 and switches the operation in accordance with the states of the stop, the heating mode, and the cooling mode.

The expansion valve 13 is a valve that decompresses and expands the liquid phase refrigerant supplied from the heat exchanger 10. In the present embodiment, the expansion valve 13 which is the valve body and the electric drive unit (motor) 42 which is configured to operate the expansion valve 13 and will be described later, are integrated to form the electric expansion valve device 30. The specific configuration of the expansion valve device 30 will be described later. The expansion valve 13 decompresses the liquid-phase refrigerant in the low temperature and high pressure state and supplies the refrigerant to the evaporator 14.

The evaporator 14 is a cooling heat exchanger for cooling conditioned air in the cooling mode. The liquid-phase refrigerant supplied from the expansion valve 13 to the evaporator 14 exchanges heat with air around the evaporator 14 (in the duct of the vehicle air conditioner). This heat exchange causes the liquid-phase refrigerant to be vaporized and causes the air around the evaporator 14 to be cooled. Subsequently, the refrigerant in the evaporator 14 flows out toward the compressor 11 and is compressed again in the compressor 11.

Next, the detailed configuration of the expansion valve device 30 of the present embodiment will be described.

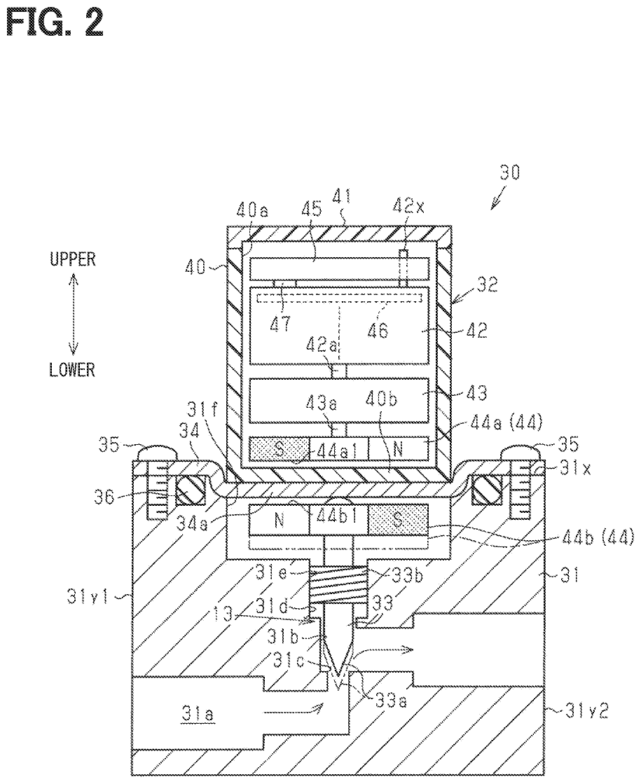

As shown in FIG. 2, the expansion valve device 30 includes a base block 31, the expansion valve 13 provided in the base block 31, and a drive device 32 that is integrally fixed to the base block 31 to drive the expansion valve 13.

The base block 31 is provided with an inflow path 31a that causes the refrigerant to flow from the second heat exchange portion 22 into the evaporator 14. The inflow path 31a functions as a part of the circulation path. The inflow path 31a has a circular passage shape in cross section. The base block 31 has a substantially rectangular parallelepiped shape. Assuming that one surface of the base block 31 on which the drive device 32 is fixed is an upper surface 31x (hereinafter, the base block 31 will be described as the lower side and the drive device 32 will be described as the upper side), the inflow path 31a is formed so as to penetrate from the side surface 31y1 on one side toward the side surface 31y2 on the opposite side.

In the middle of the inflow path 31a, a vertical passage 31b is provided to extend in the vertical direction orthogonal to the direction in which the inflow path 31a extends. The upper side of the vertical passage 31b communicates with a valve accommodating hole 31d having a circular cross section. A valve body 33 is accommodated in the valve accommodating hole 31d. The valve body 33 is a needle-shaped valve body and has a tip portion 33a pointed downward. That is, the expansion valve 13 includes a needle valve. The valve body 33 moves forward and backward along its own axial direction (vertical direction in FIG. 2), thereby to cause the tip portion 33a to open and close the opening 31c of the vertical passage 31b. In this way, the expansion valve 13 allows and disallows flow of refrigerant in the inflow path 31a and further adjusts the flow amount of refrigerant.

The valve body 33 includes the tip portion 33a, a male screw portion 33b located at the intermediate portion, and a driven-side rotary body 44b located at the base end portion. The driven-side rotary body 44b forms a part of the magnetic joint (magnet coupling) 44 as described later. The male screw portion 33b is screwed with a female screw portion 31e formed on the inner peripheral surface of the valve accommodating hole 31d. The male screw portion 33b converts a rotary motion of the valve body 33 into a linear motion of the valve body 33 in the axial direction (vertical direction). The driven-side rotary body 44b is coaxially fixed to a base end portion of the valve body 33. The driven-side rotary body 44b forms the magnet coupling 44 in pairs with a driving-side rotary body 44a as described later. That is, the driving-side rotary body 44a and the driven-side rotary body 44b are magnetically coupled with each other in a non-contact manner. When the driven-side rotary body 44b is rotated in response to rotation of the driving-side rotary body 44a, the valve body 33 rotates accordingly. The rotary motion of the valve body 33 is converted into the linear motion of the valve body 33 in the axial direction, that is, an opening and closing operation of the expansion valve 13, by using the male screw portion 33b and the female screw portion 31e.

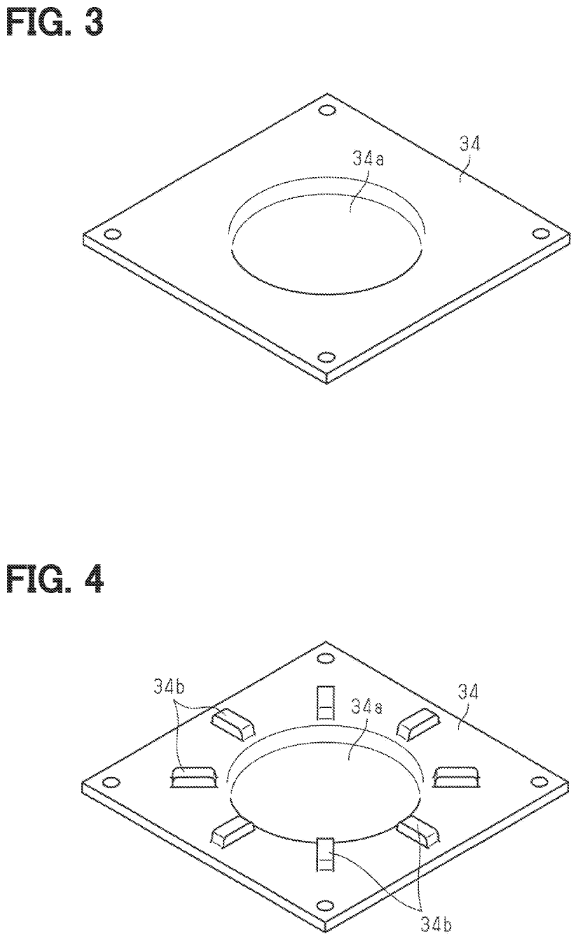

A closing plate 34 for closing an opening 31f of the valve accommodating hole 31d is fixed to the upper surface 31x of the base block 31 with a fixing screw 35. The closing plate 34 is formed of a flat plate material made of metal (for example, made of a SUS material). As shown in FIGS. 2 and 3, the closing plate 34 has a recessed portion 34a at the center thereof. The recessed portion 34a has a circular cross section and is recessed downward. The recessed portion 34a has an outer shape that bulges downward, specifically has a shape that corresponds to the opening 31f of the valve accommodating hole 31d. The recessed portion 34a is configured to be inserted in the opening 31f. The recessed portion 34a of the closing plate 34 functions as a partition wall that closes the valve accommodating hole 31d. The recessed portion 34a itself has a recessed shape (bulging shape). Therefore, the closing plate 34 including the part, which functions as the partition wall that receives the refrigerant pressure, has a high rigidity. Further, a part of the drive device 32 is inserted in the recessed portion 34a. Therefore, a degree by which the drive device 32 protrudes from the base block 31 is suppressed.

Further, a ring-shaped seal ring 36 is interposed between the closing plate 34 and the upper surface 31x of the base block 31 so as to surround the periphery of the opening 31f. That is, the opening 31f of the base block 31 is liquid-tightly closed with the closing plate 34 and the seal ring 36. Therefore, refrigerant does not leak to the outside (to the drive device 32 side or the like) from the base block 31.

The drive device 32 is fixed to the upper surface 31x of the base block 31 by using mounting screws (not shown) or the like so as to interpose the closing plate 34 therebetween. The drive device 32 includes a housing 40 having an opening 40a on the upper surface thereof and a cover 41 that closes the opening 40a of the housing 40. The drive device 32 further accommodates the electric drive unit 42 accommodated in the housing 40, a speed reduction unit 43, the driving-side rotary body 44a of the magnet coupling 44, and a circuit board 45.

The electric drive unit 42, the speed reduction unit 43, and the driving-side rotary body 44a of the magnet coupling 44 are provided on the axis of the valve body 33 (driven-side rotary body 44b) of the expansion valve 13. The speed reduction unit 43 is arranged below the electric drive unit 42. The driving-side rotary body 44a of the magnet coupling 44 is arranged below the speed reduction unit 43.

The electric drive unit 42 includes, for example, a stepping motor, a brushless motor, or a motor with a brush, or the like. The electric drive unit 42 is connected to the circuit board 45 via multiple connection terminals 42x and receives electric power from the circuit board 45 via the connection terminals 42x. The electric drive unit 42 is rotationally driven based on the power supply from the circuit board 45 (control circuit) to rotate a rotary shaft 42a. Further, the electric drive unit 42 includes a detected object (sensor magnet) 46 that rotates integrally with the rotary shaft 42a. The rotary information (rotary position, speed, and the like) of the rotary shaft 42a is detected by detecting the detected object 46 by using a position detection unit (Hall IC) 47 of the circuit board 45. The rotary shaft 42a of the electric drive unit 42 projects from the lower side of its main body and is connected to the speed reduction unit 43 in a drivable manner.

The speed reduction unit 43 includes, for example, a reduction gear mechanism using multiple gears. The speed reduction unit 43 decelerates and increases a torque of the rotation of the rotary shaft 42a of the electric drive unit 42 outputs the torque with an output shaft 43a. The output shaft 43a protrudes from the lower side of the speed reduction unit 43. The tip portion of the output shaft 43a is coaxially fixed to the driving-side rotary body 44a of the magnet coupling 44.

The magnet coupling 44 includes the driving-side rotary body 44a and the driven-side rotary body 44b, which are arranged coaxially with each other. Further, the magnetically opposed surface 44a1 of the driving-side rotary body 44a is opposed to the bottom surface portion 40b of the housing 40. In addition, the magnetically opposed surface 44b1 of the driven-side rotary body 44b is opposed to the closing plate 34 (recessed portion 34a). In other words, the bottom surface portion 40b of the housing 40 and the closing plate 34, which are in a form of overlapping with each other, are interposed between the driving-side rotary body 44a and the driven-side rotary body 44b. That is, although the bottom surface portion 40b of the housing 40 and the closing plate 34 are interposed therebetween, the driving-side rotary body 44a and the driven-side rotary body 44b are configured such that the magnetic opposed surfaces 44a1 and 44b1 are magnetically coupled to each other to enable to rotate with each other.

Further, the space in the housing 40, in which the driving-side rotary body 44a is accommodated, and the space in the base block 31, in which the driven-side rotary body 44b is accommodated, are liquid-tightly partitioned from each other with the closing plate 34 (bottom surface portion 40b of the housing 40). That is, the driven-side rotary body 44b is arranged in the space where the refrigerant exists, while the driving-side rotary body 44a is arranged in the space which is partitioned from the space where the refrigerant exists. In this configuration, in addition to the driving-side rotary body 44a, the speed reduction unit 43, the electric drive unit 42, and the circuit board 45 are also arranged in the space that is liquid-tightly partitioned from the space in which the refrigerant exists. The configuration prevents intrusion of the refrigerant into the housing 40.

The circuit board 45 is arranged in the vicinity of the opening 40a of the housing 40 above the electric drive unit 42. The circuit board 45 is mounted with various electronic components (not shown) to form the control circuit that controls the driving of the electric drive unit 42. The circuit board 45 is arranged so that its plane direction is orthogonal to the axial direction of the electric drive unit 42.

The control circuit of the circuit board 45 controls the rotation and driving of the electric drive unit 42, thereby to adjust the advancing or retreating position of the valve body 33 of the expansion valve 13 via the speed reduction unit 43 and the magnet coupling 44 and to adjust an amount of refrigerant supplied to the evaporator 14. That is, the control circuit of the circuit board 45 controls the opening and closing of the expansion valve 13 (expansion valve device 30) in conjunction with the integrated valve device 24 of the vehicle air conditioner, thereby to perform the air conditioning control together with a control circuit that controls the integrated valve device 24.

The effects of this embodiment will be described.

(1) The expansion valve device 30 is configured to convert the rotary drive motion of the electric drive unit (motor) 42 into the linear motion (advance and retreat motion) of the valve body 33 via the magnet coupling 44 and the screw mechanism (the male screw portion 33b and the female screw portion 31e). This configuration enables to cause an attractive force generated in the magnet coupling 44 (that is, an attractive force between the driving-side rotary body 44a and the driven-side rotary body 44b) to act on the screw mechanism (screw portions 33b, 31e) that has the structure to cause rattling. Therefore, the configuration enables to suppress the rattling of the screw mechanism (screw portions 33b, 31e) and the rattling of the valve body 33 without using an urging component.

(2) The opening 31f of the valve accommodating hole 31d is liquid-tightly closed with the closing plate 34. Specifically, the closing plate 34 is interposed (in the present embodiment, the bottom surface portion 40b of the housing 40 is also interposed) between the driving-side rotary body 44a provided in the drive device 32 and the driven-side rotary body 44b provided in the base block 31. Therefore, the structure using the magnet coupling 44 and the closing plate 34 enables to more reliably restrict infiltration of the refrigerant into the electric drive unit 42 (inside the drive device 32) through the drive transmission path which is likely to become the infiltration path of the refrigerant.

(3) The closing plate 34 is provided with the recessed portion 34a as a deformation suppressing portion to increase the rigidity of the closing plate 34. Consequently, the configuration enables to suppress deformation of the closing plate 34 that receives the pressure of refrigerant. Further, the recessed portion 34a enables to readily enhance rigidity of the closing plate 34. Further, a part of the drive device 32 is accommodated in the recessed portion 34a, thereby to enable to suppress the degree by which the drive device 32 protrudes from the base block 31 and to enable to expect downsizing of the entirety of the expansion valve device 30.

(4) The base block 31 has the inflow path 31a which is a part of the circulation path of the refrigeration cycle device D and accommodates the expansion valve 13. The drive device 32 is integrally fixed to the base block 31 to form a component unit. Therefore, the configuration may enable to facilitate assembling of the expansion valve device 30 and the like.

(5) In the housing 40, the distance between the circuit board 45 and the base block 31 is longer than the distance between the electric drive unit 42 and the base block 31. That is, the circuit board 45 is arranged at a position (on the side of the opening 40a) away from the base block 31 having the refrigerant circulation path. Therefore, in the structure in which the circuit board 45 is arranged on the upper side, even in a case where the refrigerant infiltrates into the housing 40, the configuration enables to restrict infiltration of the refrigerant to the circuit board 45 and to protect the circuit board 45 from damage.

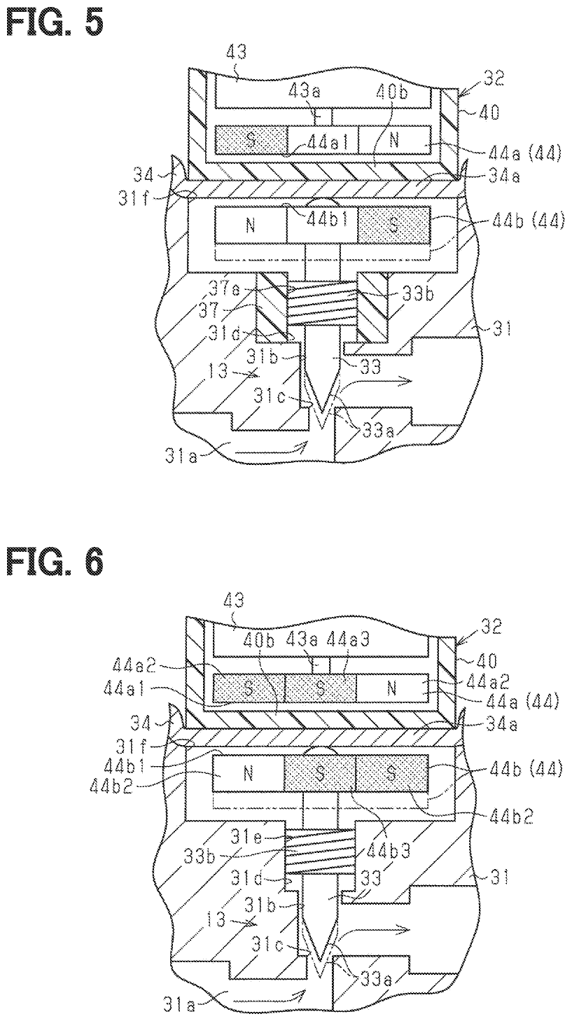

The above described embodiments may be modified as follows. The above described embodiments and the following modifications can be implemented in combination with one another as long as there is no technical contradiction.
The recessed portion 34a is formed in the closing plate 34, and the recessed portion 34a is caused to function as the deformation suppressing portion of the closing plate 34. It is noted that, the deformation suppressing portion is not limited to this. For example, as shown in FIG. 4, multiple reinforcing ribs 34b extending radially outward and arranged at a constant angular interval may be provided around the recessed portion 34a on the plate surface of the closing plate 34. In this case, the multiple reinforcing ribs 34b may be caused to function as the deformation suppressing portion. As the deformation suppressing portion, both the recessed portion 34a and the reinforcing rib 34b may be provided as shown in FIG. 4. It is noted that, only one of the recessed portion 34a and the reinforcing rib 34b may be provided. The reinforcing rib 34b enables to enhance rigidity of the closing plate 34 easily. Further, the reinforcing ribs 34b provided around the recessed portion 34a enable to significantly enhance the rigidity of the closing plate 34.
A part of the configuration of the screw mechanism (screw portions 33b, 31e) of the embodiment has not been particularly mentioned. Both the male screw portion 33b of the valve body 33 and the female screw portion 31e of the valve accommodating hole 31d may be made of a metallic material, alternatively, at least one of them may be made of a resin material. For example, as shown in FIG. 5, a part of the inner peripheral surface of the valve accommodating hole 31d may be replaced with a resin member 37 having a female screw portion 37a. The configuration, in which the male screw portion 33b of the valve body 33 made of a metallic material is screwed in the female screw portion 37a of the resin member 37, enables to expect reduction in the sliding resistance of the valve body 33 and reduction in the magnetic force of the magnet coupling 44.
Although not particularly mentioned in the embodiment, the driving-side rotary body 44a and the driven-side rotary body 44b of the magnet coupling 44 are configured to form, at least at the radially outer portions, an attractive portion in which different poles attract to each other. Instead of this configuration, as shown in FIG. 6, attractive portions 44a2, 44b2 on the outer side in the radial direction and repulsive portions 44a3, 44b3 on the inner side in the radial direction may be mixed. That is, in a configuration in which the attractive force of the attractive portions 44a2, 44b2 becomes intense due to its magnetic material or the like, the repulsive portions 44a3, 44b3 on the inner side in the radial direction may enable to offset a part of the attractive force. Therefore, the configuration enables to appropriately adjust the attractive force between the driving-side rotary body 44a and the driven-side rotary body 44b.

The circuit board 45 is arranged near the opening 40a of the housing 40 and above the electric drive unit 42, however, the present disclosure is not limited to this configuration. For example, the circuit board 45 may be arranged such that its plane direction is along the vertical direction. In this case, the circuit board 45 may be arranged along the lateral surface of the housing 40.

The speed reduction unit 43 is formed of a reduction mechanism that uses multiple gears. It is noted that, the speed reduction unit 43 is not limited to the mechanical reduction mechanism such as a gear train and a planetary gear. For example, the speed reduction unit 43 may use a magnetic speed reduction unit that can be combined together with the magnet coupling 44. Further, the speed reduction unit 43 may be a speed increasing mechanism instead of the speed reduction mechanism. Further, the speed reduction mechanism and the speed increasing mechanism may be omitted.

In the expansion valve device 30, the base block 31 is arranged on the lower side, and the drive device 32 is arranged on the upper side, however, the arrangement structure is not limited to this and may be appropriately modified.

The present disclosure may be applied to valves other than the expansion valve device 30 (expansion valve 13) and may be applied to, for example, the integrated valve device 24 in the refrigeration cycle device D of the embodiment.
The present disclosure is applied to the refrigeration cycle device D for a vehicle air conditioner, however, the present disclosure may be applied to a valve device used in a refrigerant circulation path of another refrigeration cycle device, such as a refrigeration cycle device for an air conditioner other than that for a vehicle, a refrigeration cycle device for battery cooling other than that for air conditioning, and the like.
Although the present disclosure has been described in accordance with the examples, it is understood that the present disclosure is not limited to such examples or structures. The present disclosure encompasses various modifications and variations within the scope of equivalents. In addition, while the various combinations and configurations, which are preferred, other combinations and configurations, including more, less or only a single element, are also within the spirit and scope of the present disclosure.

What is claimed is:

1. A valve device comprising:
a valve including a valve body and configured to change a flow mode of refrigerant that flows in a circulation path of a refrigeration cycle device;
a drive device configured to drive the valve and including an electric drive unit as a drive source;
a magnet coupling including a driving-side rotary body and a driven-side rotary body that are magnetically coupled to each other in a non-contact manner, the magnet coupling configured to transmit a rotary motion of the electric drive unit from the driving-side rotary body to the driven-side rotary body; and
a screw mechanism configured to convert the rotary motion of the driven-side rotary body into a linear motion of the valve body in an axial direction, wherein
the valve device is configured to change the flow mode of refrigerant by using the linear motion of the valve body caused via the magnet coupling and the screw mechanism in response to driving of the electric drive unit.

2. The valve device according to claim 1, further comprising:
a base block that forms a part of the circulation path of the refrigeration cycle device and has a valve accommodating hole accommodating the valve body; and
a closing plate that liquid-tightly closes an opening of the valve accommodating hole, wherein
the driving-side rotary body is provided in the drive device,
the driven-side rotary body is provided in the base block, and
the closing plate is interposed between the driving-side rotary body and the driven-side rotary body.

3. The valve device according to claim 2, wherein
the closing plate has a deformation suppressing portion that is configured to suppress deformation due to pressure applied from refrigerant.

4. The valve device according to claim 3, wherein
the deformation suppressing portion includes a recessed portion that bulges into the opening of the valve accommodating hole and is in a recessed shape.

5. The valve device according to claim 3, wherein
the deformation suppressing portion includes a reinforcing rib provided on a plate surface of the closing plate.

6. The valve device according to claim 1, wherein
each of the driving-side rotary body and the driven-side rotary body includes an attractive portion on an outer side in a radial direction and a repulsive portion on an inner side in the radial direction.

7. The valve device according to claim 1, wherein
the refrigeration cycle device is a vehicular refrigeration cycle device mounted on a vehicle.
